(19) United States
(12) Patent Application Publication
(10) Pub. No.: US 2005/0094727 A1
(43) Pub. Date: May 5, 2005

(54) Method and apparatus for motion estimation

(75) Inventors: Hyeong-seok Ha, Suwon-si (KR); Nam-suk Lee, Seoul (KR); So-young Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/972,668

(22) Filed: Oct. 26, 2004

(30) Foreign Application Priority Data
Oct. 30, 2003 (KR) 2003-76413

(51) Int. Cl. H04N 7/12

(52) U.S. Cl. 375/240.12; 348/699; 375/240.24; 375/240.18; 375/240.03

(57) ABSTRACT

A method and apparatus for motion estimation, the method including selecting one candidate reference picture from a plurality of reference pictures based on priorities of the plurality of reference pictures to determine a reference picture of a predetermined block that belongs to a plurality of blocks forming a present picture and performing motion estimation on the predetermined block using the selected candidate reference picture.

### CROSS-REFERENCE TO RELATED APPLICATION

This application claims the benefit of Korean Patent Application No. 2003-76413, filed on Oct. 30, 2003 in the Korean Intellectual Property Office, the disclosure of which is incorporated herein by reference.

### BACKGROUND OF THE INVENTION

1. Field of the Invention

The present invention relates to a method and apparatus for video encoding, and more particularly, to a method and apparatus for estimating motion.

2. Description of the Related Art

According to H.264 standards introduced for encoding and decoding of video data, encoding or decoding is performed in units of a plurality of macro blocks or sub blocks (that are acquired by dividing one macroblock into two or four parts) included in a picture. Encoding and decoding is performed based on prediction. Prediction is performed with reference to a past picture or both a past picture and a future picture on a basis of a time axis. A picture, which is referred to for encoding or decoding of a presently encoded or decoded picture (hereafter, referred to as a present picture), is called a reference picture.

According to H.264 standards, the reference picture is determined based on a multiple reference method in which a macro block and/or a sub block can refer to different reference pictures. In other words, recently encoded pictures whose number is not less than 1 and not more than 16 are stored, all the stored reference pictures are used in motion estimation, and a picture demonstrating the best performance is determined to be a reference picture of a block on which motion estimation is to be performed (hereafter, referred to as a present block). Thus, compression efficiency or display quality is improved in comparison to a conventional method in which only one reference picture is used.

However, since the optimal reference picture is selected only after motion estimation is performed on all reference pictures, the amount of computation remarkably increases. Moreover, in accordance with H.264 standards, the reference picture can be selected in units of not only 16×16 macroblocks but also 8×8 sub blocks. As a result, the number of reference pictures greatly increases and the amount of computation greatly increases accordingly. In particular, there is difficulty implementing real-time encoding and decoding due to the increasing amount of computation.

### SUMMARY OF THE INVENTION

The present invention provides a method and apparatus of motion estimation, in which the amount of computation imposed on an encoder can be reduced by performing motion estimation on several reference pictures having high possibility of being determined to be a reference picture instead of performing motion estimation on all plural reference pictures.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a configuration of an encoder according to an embodiment of the present invention;

FIG. 2 illustrates a configuration of a decoder according to an embodiment of the present invention;

FIG. 3 illustrates in detail a configuration of a motion estimating unit 600 shown in FIG. 1;

FIG. 4 illustrates a portion of a picture used according to an embodiment of the present invention; and

FIGS. 5A through 5C are flowcharts illustrating a method of motion estimation according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

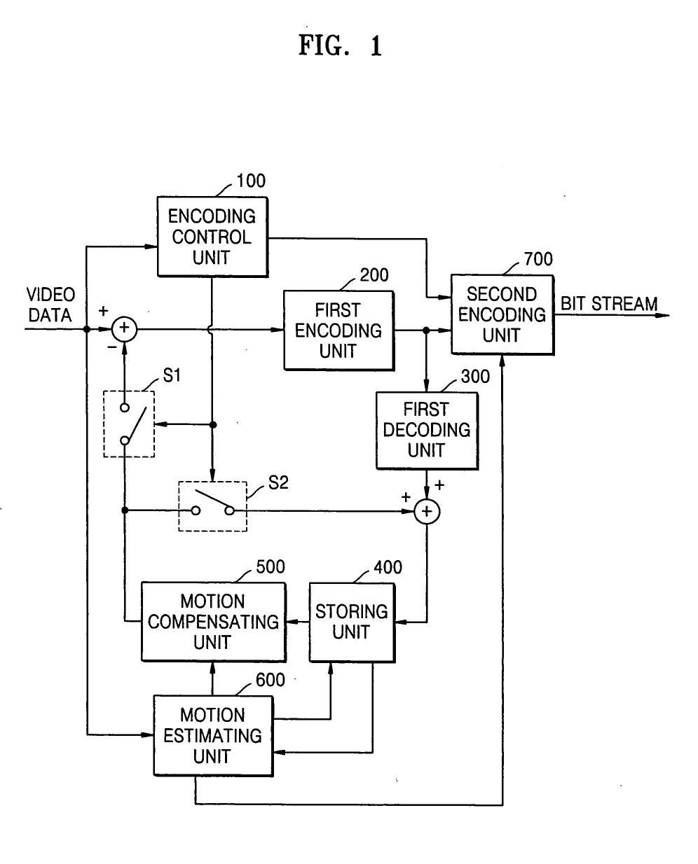

FIG. 1 illustrates a configuration of an encoder according to an embodiment of the present invention.

Referring to FIG. 1, the encoder adopts a multiple reference method by which a plurality of past pictures and/or future pictures can be referred for encoding a present picture. The encoder includes an encoding control unit 100, a first encoding unit 200, a second encoding unit 700, a first decoding unit 300, a storing unit 400, a motion compensating unit 500, and motion estimating unit 600.

The storing unit 400 stores a reference index list and a plurality of pictures referred to by the reference index list, according to the present invention. The motion compensating unit 500 performs motion compensation according to the present invention and the motion estimating unit 600 determines a reference picture and performs motion compensation using the determined reference picture according to the present invention.

The encoder according to an embodiment of the present invention is distinguished from a conventional encoder particularly in terms of the motion estimating unit 600. According to this embodiment, the motion estimating unit 600 assigns different priorities to a plurality of reference pictures and performs motion estimation in high to low priority order. As a result of motion estimation, if a residue cost is less than a predetermined threshold, the motion estimating unit 600 does not perform motion estimation on low-priority reference pictures and terminates motion estimation early. In other words, the motion estimating unit 600 does not perform motion estimation on all the reference pictures included in the reference index list as in conventional art, but only performs motion estimation on several reference pictures having high possibility of being determined to be a reference picture, thereby performing motion estimation with high efficiency. Priorities are assigned based on the following two standards. First, a picture that is temporally close to a present picture has high possibility of being determined to be a reference picture. Second, a reference picture of a neighboring block has high possibility of being determined to be a reference picture. In this embodiment, to assign priorities to a plurality of reference pictures, each reference picture is classified as follows.

In the case of the temporally closest reference picture with the highest priority, the reference picture is determined to be of a first type. Next, in the case of a reference picture of neighboring blocks of present blocks, the reference picture is determined to be of a second type. However, the reference picture determined to be of the second type does not include a reference picture that is already determined to be of the first type. Next, in the case of a reference picture of blocks included in a slice including a present block, the reference picture is determined to be of a third type. However, the reference picture determined to be of the third type does not include a reference picture that is already determined to be of the first type or the second type. Next, in the case of reference pictures included in the reference index list, the reference pictures are determined to be of a fourth type. However, the reference picture determined to be of the fourth type does not include a reference picture that is already determined to be of the first type, the second type, or the third type.

Once video data is input, the encoding control unit 100 determines a coding type (intra coding/inter coding) according to whether motion compensation is to be performed on input video data and outputs a corresponding control signal to a first switch S1. If motion compensation is to be performed, i.e., inter coding is to be performed, previous and/or next input video data is required and thus the first switch S1 is closed. If motion compensation is not to be performed, i.e., intra coding is to be performed, the previous and/or next input video data is not required and thus the first switch S1 is opened. If the first switch S1 is closed, difference video data obtained from the input video data and the previous and/or next input video data is input to the first encoding unit 200. If the first switch S1 is opened, the input video data is only input to the first encoding unit 200.

In this embodiment, if the first switch S1 is opened, video data input to the first encoding unit 200 is I pictures. If the first switch S1 is closed, video data input to the first encoding unit 200 is P pictures or B pictures. In other words, video data to be encoded includes a plurality of pictures. The I pictures indicate Intra pictures that are obtained without reference to other pictures. The B pictures indicate Bi-predictive pictures that are obtained with reference to two different pictures. The P pictures indicate predictive pictures only obtained with reference to the I pictures. In this embodiment, encoding is performed in units of blocks. Thus, blocks to be mentioned below means a plurality of macroblocks forming a picture or subblocks obtained by horizontally or vertically dividing the plurality of macroblocks into two or four parts.

The first encoding unit 200 obtains transform coefficients by transforming a picture, quantizes the obtained transform coefficients, and outputs quantized transform coefficients. The transform may be discrete cosine transform (DCT) or wavelet transform.

Since a picture, which is input to the first encoding unit 200 and then encoded, may be used as a reference picture for motion compensation of a next or previous input block, it undergoes a process inverse to that of the first encoding unit 200, i.e., dequantization and inverse transform, in the first decoding unit 300 and is then stored in the storing unit 400. The motion estimating unit 600 determines a reference picture with reference to the reference index list and a plurality of pictures stored in the storing unit 400 according to an embodiment of the present invention. Determination of the reference picture will be descried in detail later. Also, the motion estimating unit 600 calculates a motion vector based on the determined reference picture. The motion vector is calculated with reference to a plurality of past and/or future pictures.

The motion compensating unit 500 reads from the storing unit a reference picture indicated by the motion vector calculated by the motion estimating unit 600, performs motion compensation based on the reference picture and the motion vector, and outputs a motion compensation value obtained as a result of motion compensation. The motion compensation value is added to data output from the first decoding unit 300, restored into a picture forming input video data, and stored in the storing unit 400 for use in motion estimation or motion compensation.

The second encoding unit 700 receives, encodes, and then multiplexes the quantized transform coefficients output from the first encoding unit 200, the motion vector output from the motion estimating unit 600, and information required for decoding such as coding type information and quantization parameter information provided from the encoding control unit 100, thus outputting a bit stream. In this embodiment, the second encoding unit 700 performs entropy encoding.

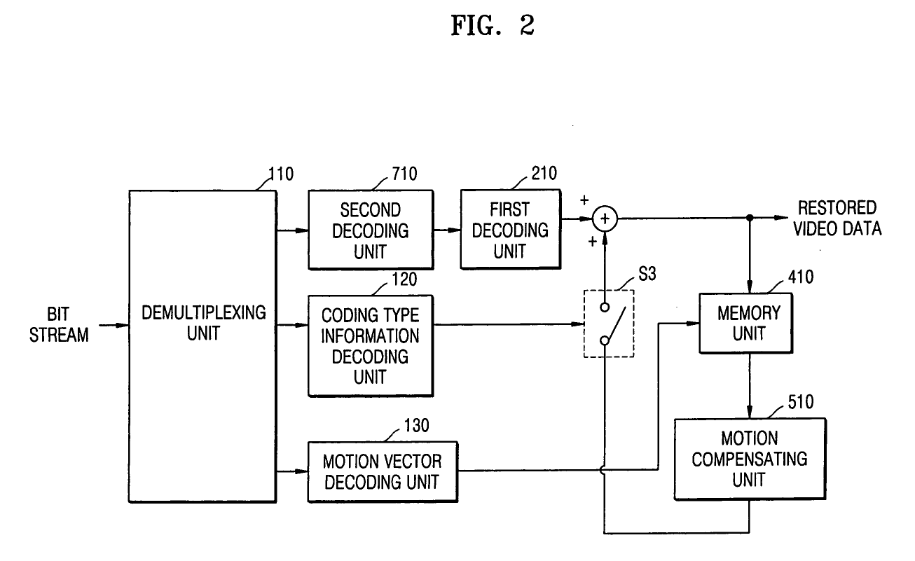

FIG. 2 illustrates a configuration of a decoder according to an embodiment of the present invention.

Referring to FIG. 2, a decoder decodes a bit stream including video data encoded by the encoder of FIG. 1. The decoder of FIG. 2 includes a demultiplexing unit 100 that demultiplexes a bit stream, a second decoding unit 710, and a first decoding unit 210. Also, the decoder of FIG. 2 includes a coding type information decoding unit 120 that decodes coding type information and a motion vector decoding unit 130 that decodes a motion vector. Also, the decoder of FIG. 2 includes a storing unit 410 and a motion compensating unit 510.

The demultiplexing unit 110 demultiplexes a received bit stream and outputs encoded and quantized transform coefficients, motion vector information, and coding type information. The second decoding unit 710 outputs quantized transform coefficients by performing entropy decoding on encoded transform coefficients. The first decoding unit 210 decodes the quantized transform coefficients. In other words, the first decoding unit 210 operates inversely to the first encoding unit 200 of FIG. 1. For example, if the first encoding unit 200 performs DCT, the first decoding unit 210 performs inverse discrete cosine transform (IDCT). Likewise, if the first encoding unit 200 performs wavelet transform, the first decoding unit 210 performs wavelet inverse transform. Thus, video data is restored. The restored video data is stored in the storing unit 410 for motion compensation.

The coding type information decoding unit 120 identifies a coding type by decoding the coding type. If the coding type is the inter type that needs motion compensation, a third switch S3 is closed, a motion compensation value output from the motion compensating unit 510 is added to data output from the first decoding unit 210, and thus a restored picture can be obtained. The motion vector decoding unit 130 decodes the motion vector and the motion compensating unit 510 outputs a motion compensation value created by using a reference picture indicated by the decoded motion vector.

In particular, the motion compensating unit 510 uses a reference picture determined according to the present invention when performing motion compensation. In other words, a reference picture is used, which is determined by preferentially performing motion estimation on a picture temporally close to a present picture or a reference picture of a neighboring block of the present picture. The reference picture determined according to the present invention is stored in the storing unit 410.

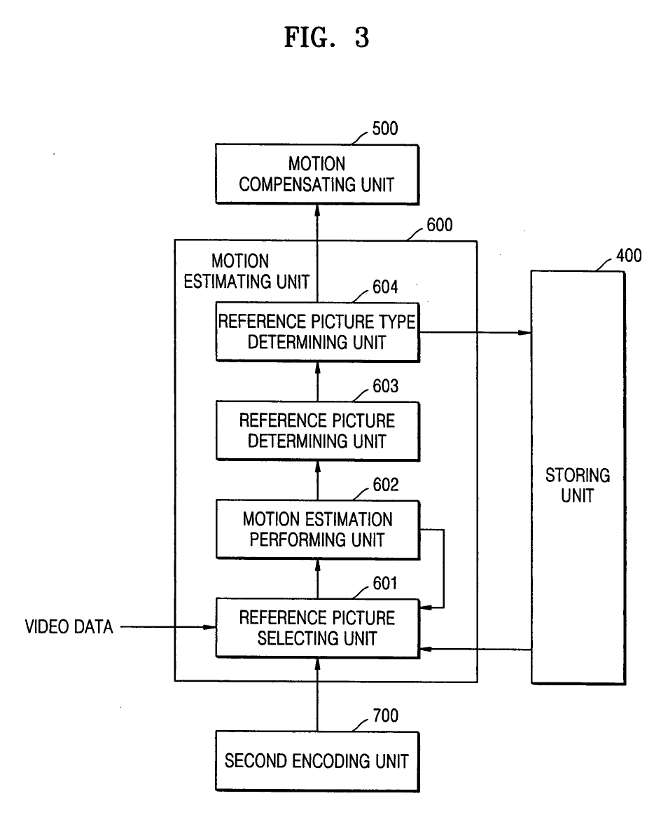

FIG. 3 illustrates in detail a configuration of a motion estimating unit 600 shown in FIG. 1.

Referring to FIG. 3, the motion estimating unit 600 includes a reference picture selecting unit 601, a motion estimation performing unit 602, a reference picture determining unit 603, and a reference picture type determining unit 604.

The reference picture selecting unit 601 selects one reference picture from a plurality of reference pictures based on priorities of the plurality of reference pictures to determine a reference block of a predetermined block. The motion estimation performing unit 602 performs motion estimation on the predetermined block using the selected reference picture. If a result of motion estimation is less than a predetermined threshold, the reference picture determining unit 603 determines a reference picture, which is used to obtain the result that is less than the predetermined threshold, to be a reference block of the predetermined block. Here, the plurality of reference pictures are included in a reference index list and the result is the residue cost. Also, to clearly distinguishing the selected reference picture and the determined reference picture, the selected reference picture may be called a candidate reference picture. Hereinafter, the motion estimating unit 600 according to an embodiment of the present invention will be described in detail.

The reference picture selecting unit 601 selects a candidate reference picture of a present block from a plurality of blocks forming a present picture, where the candidate reference picture is temporally closest to the present picture among reference pictures included in the reference index list at a time point when motion estimation is performed on the present block. The principle of video is to show pictures without visual discontinuity by alternating successive pictures rapidly such that a human cannot perceive the alternation. Thus, there is a high possibility that the temporally closest reference picture is most similar to the present picture. However, in the case of video whose motion change is large and motion is repeated (e.g., eye blinking), another picture that is not temporally closest to the present picture may be the most similar to the present picture.

The motion estimation performing unit 602 performs motion estimation on the present block using the temporally closest reference picture. As a result of motion estimation, a motion vector that indicates the relative amount of motion of the present block in comparison to a block corresponding to the present block (hereinafter, referred to as a corresponding block), which is included in the reference block, and a residue cost that indicates the degree of similarity of the present block to the corresponding block are calculated. The calculated motion vector and residue cost are stored in the storing unit 400 of FIG. 1. As the residue cost is smaller, the present block and the corresponding block are more likely to be similar to each other. The residue cost may be sum of absolute differences (SAD) or sum of absolute hadamard transformed differences (SATD).

If a residue cost, which is obtained as a result of motion estimation performed using the temporally closest reference picture, is less than a predetermined threshold, the reference picture determining unit 603 determines the temporally closest reference picture to be the reference picture of a block. Here, the threshold is determined based on the performance of the encoder of FIG. 1. If the performance of the encoder is superior, by setting the threshold to a small value, it is possible to find out a more accurate reference picture even when motion estimation is performed on a large number of reference pictures. If the performance of the encoder is bad, by setting the threshold to a large value, it is possible to complete motion estimation early and to play back video on a real-time basis without fail, though a slight inaccurate reference picture is found.

If the temporally closest reference picture is determined to be a reference picture, the reference picture type determining unit 604 determines the type of the temporally closest reference picture to be the first type. Here, the type of the determined reference picture is used as a basis of a priority for next motion estimation.

If the residue cost obtained as a result of motion estimation performed using the temporally closest reference picture is not less than the threshold, the reference picture selecting unit 601 selects a reference picture of neighboring blocks of a present block from reference pictures included in the reference index list. The next similar picture to the present picture but the most similar picture that is temporally closest to the present picture is a reference picture of neighboring blocks of the present block. This is because the reference pictures of the neighboring blocks of the present block have high possibility of being a reference picture of the present block since video data continuously changes by nature. However, since the temporally closest reference picture is already motion estimated, it is excluded from the subject of selection.

Since the temporally closest reference picture is only one, there is no problem concerning selection. However, since there are a plurality of reference pictures of neighboring blocks of the present block, a problem concerning selection of a reference picture from the plurality of reference pictures is created. Thus, it is necessary to assign priorities to reference pictures of the neighboring blocks of the present block.

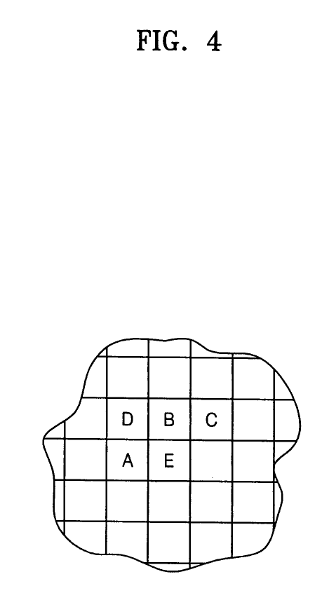

FIG. 4 illustrates a portion of a picture used according to an embodiment of the present invention.

Referring to FIG. 4, assuming that the present block is a block E, blocks A, B, C, and D are adjacent to block E and are already motion estimated. Motion estimation is performed in order of the block A, the block B, the block C, then the block D. The block E is to be motion estimated presently.

As described above, since the number of neighboring blocks of block E is 4, it is necessary to assign priorities to reference blocks of the neighboring blocks. In a similar way to the above-described method, priorities may be assigned according to the degree of correlation of the reference pictures with the present picture. In other words, the reference picture selecting unit 601 can select a reference picture among the reference pictures of the neighboring blocks in order of a reference picture having the first type, a reference picture having the second type, a reference picture having the third type, and a reference picture having the fourth type. For example, if a reference picture of block A is of the second type, a reference picture of block B is of the fourth type, a reference picture of block C is of the first type, and a reference picture of the block D is of the third type, a reference picture is selected in order of the reference picture of block C (the first type), the reference picture of block A (the second type), the reference picture of block D (the third type), and the reference picture of block B (the fourth type).

Also, priorities may be assigned according to the number of reference pictures among which a reference picture is selected. In the latter case, the fourth type has the highest priority, and high priorities are sequentially assigned to the third type, the second type, and then the first type. This is because motion estimation is only performed on reference pictures including the largest number of reference pictures having the fourth type and then a reference picture is determined among the motion-estimated reference pictures, and thus, accuracy in determining a reference picture is high. The former and the latter seem to be contradictory to each other, but the present invention tries to solve a problem concerning selection of the most preferable selection from the plurality of reference pictures included in the reference index list. According to a video playback environment, such a probability may be changed. For example, a reference picture is selected in order of the reference picture of block B (the fourth type), the reference picture of block D (the third type), the reference picture of block A (the second type), and then the reference picture of block C (the first type).

However, there still remains a problem concerning selection of a reference picture. This is because types of reference blocks of neighboring blocks of the present block may be the same. For example, if the reference block of block A is of the first type, the reference picture of block B is of the first type, the reference picture of block C is of the second type, and the reference picture of block D is of the third type, the type of the reference picture of block A and the type of the reference picture of block B are the same as each other. As a result, a problem concerning preferential selection of the reference picture of block A or the reference picture of block B still remains. Accordingly, the reference picture having the smaller residue cost is preferentially selected. Such selection is based on the idea that the smaller residue cost means that the reference picture and the present picture are more likely to be similar to each other and thus the more accurate reference picture can be obtained.

If the residue costs are also the same between the reference pictures, selection is made based on order according to an inter prediction mode of a reference picture. In other words, the reference picture of a block included in an object including the present block is preferentially selected.

The motion estimation performing unit 602 performs motion estimation on the present block using the reference pictures of the neighboring blocks. At this time, the motion vectors and the residue costs are obtained and stored in the storing unit 400 of FIG. 1.

If one of the residue costs obtained as a result of motion estimation performed using the reference pictures of the neighboring blocks is less than the threshold, the reference picture determining unit 603 determines the reference pictures having the residue costs that are less than the threshold to be the reference pictures of the present block.

The reference picture type determining unit 604 determines the type of the determined reference pictures of the neighboring blocks to be the second type. Like the first type, the type of the determined reference picture is used as a basis of a priority for the next motion estimation.

If all the residue costs obtained as a result of motion estimation performed using the reference pictures of the neighboring blocks are not less than the threshold, the reference picture selecting unit 601 selects reference pictures of blocks included in a slice including the present block from reference pictures included in the reference index list. The slice is a set of blocks that is the unit of encoding or decoding and includes more blocks than the neighboring blocks. However, since the temporally closest reference picture and the reference pictures of the neighboring blocks are already motion estimated, they are excluded from the subject of selection. Like the reference pictures of the neighboring blocks of the present block, there is a plurality of reference pictures of the blocks included in the slice. As a result, a problem concerning selection of a reference picture from the plurality of reference pictures is caused. In this case, as described above, a reference picture is selected according to the type of the reference picture, the residue cost, and/or the order according to the inter prediction mode.

The motion estimation performing unit 602 performs motion estimation on the present block using the reference pictures of the blocks included in the slice. The motion vectors and the residue costs are obtained and stored in the storing unit 400 of FIG. 1.

If one of the residue costs obtained as a result of motion estimation performed using the reference pictures of the blocks included in the slice is less than the threshold, the reference picture determining unit 603 determines the reference pictures having residue costs that are less than the threshold among the reference pictures of the blocks included in the slice, to be the reference pictures of the present block.

The reference picture type determining unit 604 determines the types of the determined reference pictures of the blocks included in the slice to be the third type. Like the first type and the second type, the determined type of the reference picture is used as a basis of priorities for next motion estimation.

If the residue costs obtained as a result of motion estimation all not less than the threshold, the reference picture selecting unit 601 selects one of the reference pictures included in the reference index list. However, the temporally closest reference picture, the reference pictures of the neighboring blocks, and the reference pictures of the blocks included in the slice are already motion estimated and thus are not subject of selection. Like the reference pictures of the neighboring blocks of the present block and the reference pictures of the blocks included in the slice, there are several reference pictures in the reference index list. As a result, a problem concerning selection of a reference picture from the reference index list is caused. In this case, as described above, the reference picture is selected using the type of the reference picture, the residue cost, and/or order according to the inter prediction mode.

The motion estimation performing unit 602 performs motion estimation on the present block using the reference pictures included in the reference index list. At this time, the motion vectors and the residue costs are obtained and then stored in the storing unit 400 of FIG. 1.

If one of the residue costs obtained as a result of motion estimation performed using the reference pictures included in the reference index list is less than the threshold, the reference picture having the residue cost, which is less than the threshold among the reference pictures included in the reference index list, to be the reference pictures of the present block.

The reference picture type determining unit 604 determines the type of the determined reference pictures to be of the fourth type. Like the first type, the second type, and the third type, the determined type of the reference picture is used as a basis of priorities for next motion estimation.

If all the residue costs obtained as a result of motion estimation performed using the reference pictures included in the reference index list are not less than the threshold, the reference picture having the smallest residue cost is determined to be the reference picture of the present picture among all the residue costs obtained as a result of motion estimation performed using the temporally closest reference picture, the reference pictures of the neighboring blocks, the reference pictures of the blocks included in the slice, and the reference pictures included in the reference index list. In other words, if all the residue costs obtained as a result of motion estimation performed using the reference pictures included in the reference index list are not less than the threshold, any reference picture satisfies the threshold. Thus, among the reference pictures included in the reference index list, the reference picture having the smallest residue cost is determined to be the reference picture of the present block.

The reference picture type determining unit 604 determines the reference picture having the smallest residue cost to be of the first type, if the temporally closest reference picture is used for motion estimation. If the reference pictures of the neighboring blocks are used, the reference picture type determining unit 604 determines the type of the determined reference picture having the smallest residue cost to be of the second type. If the reference pictures of the blocks included in the slice are used for motion estimation, the reference picture type determining unit 604 determines the type of the determined reference picture having the smallest residue cost to be of the third type. If the reference pictures included in the reference index picture are used for motion estimation, the reference picture type determining unit 604 determines the type of the determined reference picture having the smallest residue cost to be of the fourth type. If any reference picture does not satisfy the threshold and the reference picture having the smallest residue cost among the reference pictures included in the reference index list is determined to be the reference picture of the present block, the type of the reference picture is determined in the same way as when the reference picture is selected.

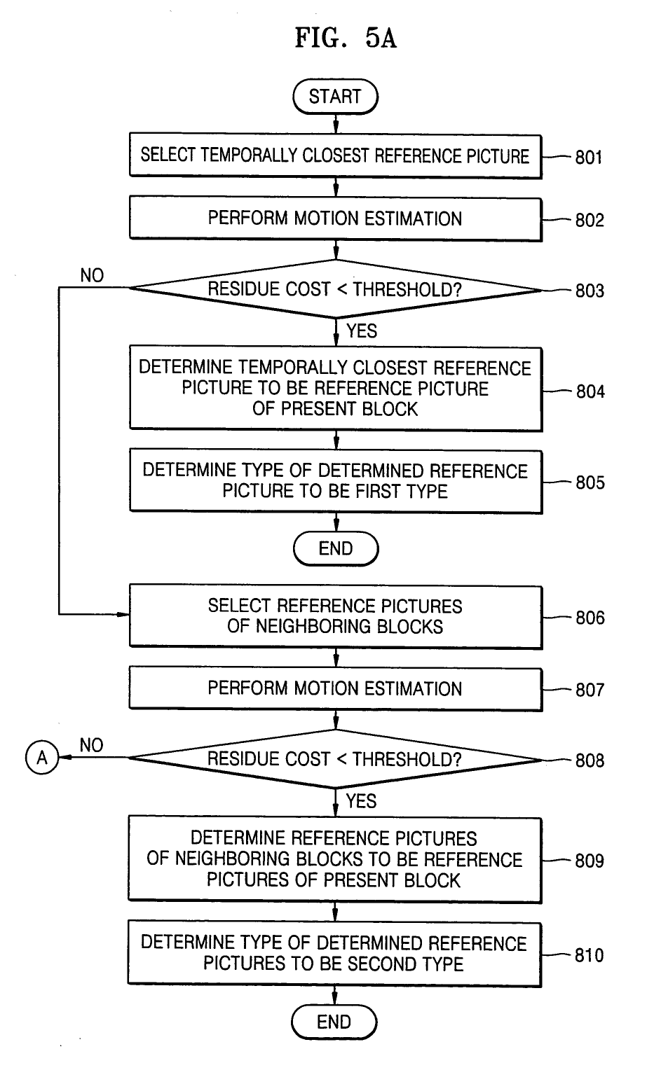

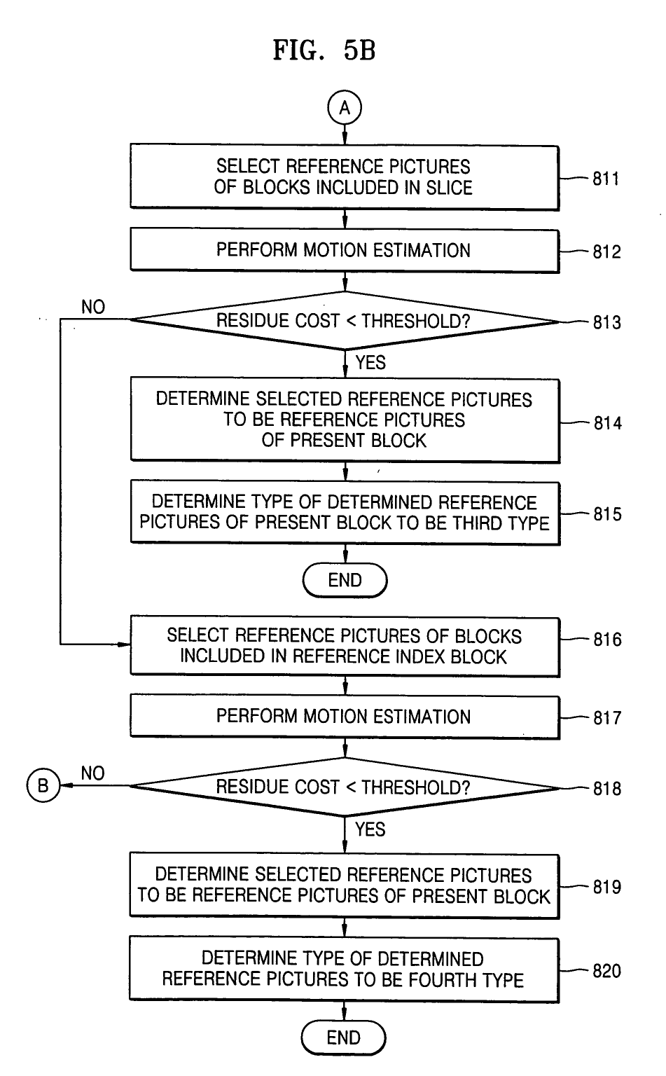

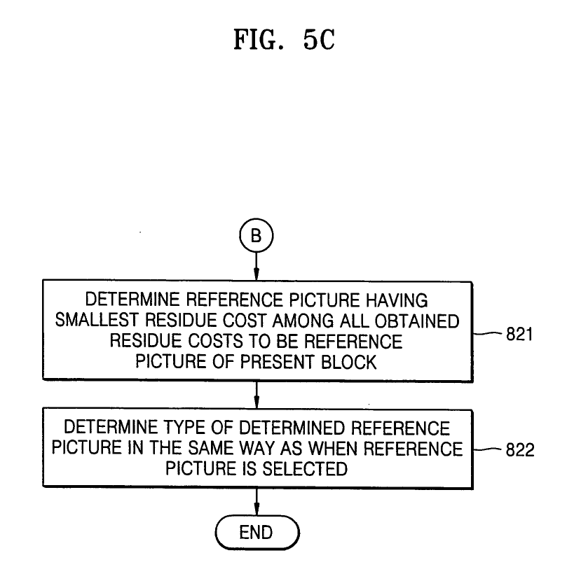

FIGS. 5A through 5C are flowcharts illustrating a method of motion estimation according to an embodiment of the present invention.

Referring to FIGS. 5A through 5C, the method of motion estimation includes several operations as follows.

To determine a reference picture of a predetermined block included in a plurality of blocks forming the present picture, one reference picture is selected from a plurality of reference pictures based on priorities of a plurality of pictures among a plurality of reference pictures. Then motion estimation is performed on the predetermined block using the selected reference block. If a value obtained as a result of motion estimation is less than a predetermined threshold, a reference picture used in obtaining the value is determined to be the reference picture of the predetermined block. Then the type of the reference pictures determined to be the reference pictures of the predetermined block is determined. Here, the plurality of reference pictures indicates reference pictures included in the reference index list and the value indicates the residue cost. Also, to clearly discriminate the selected reference picture and the determined reference picture, the selected reference picture may be called a candidate reference picture. Hereinafter, the method of motion estimation according to an embodiment of the present invention will be described in detail.

In operation 801, a reference picture that is temporally closest to a present picture is selected as a reference picture of a present block included in a plurality of blocks forming the present picture from reference pictures included in the reference index list at a time when motion estimation is performed on the present block. In operation 802, motion estimation is performed on the present block using the temporally closest reference picture. If a residue cost obtained as a result of motion estimation performed using the temporally closest reference picture is less than a threshold in operation 803, the temporally closest reference picture is determined to be the reference picture of the present block in operation 804. In operation 805, the type of the temporally closest reference picture determined to be the reference picture of the present block is determined to be the first type.

If the residue cost obtained as a result of motion estimation performed using the temporally closest reference picture is not less than the threshold in operation 803, reference pictures of neighboring blocks of the present block are selected from the reference pictures included in the reference index list in operation 806. Since there are several reference pictures of the neighboring blocks of the present block, a problem concerning selection of a reference picture from the neighboring blocks is caused. In other words, selection is made in order of a reference picture having the first type, a reference picture having the second type, a reference picture having the third type, then a reference picture having the fourth type or in order of a reference picture having the fourth type, a reference picture having the third type, a reference picture having the second type, then a reference picture having the first type. If the types of the reference pictures are the same, selection is made in order of reference pictures having the smaller residue cost. If the residue costs of the reference pictures are the same, selection is made in order according to the inter prediction mode of the reference pictures of the neighboring blocks.

In operation 807, motion estimation is performed on the present block using the reference pictures of the neighboring blocks. If one of the residue costs obtained as a result of motion estimation performed using the reference pictures of the neighboring blocks is less than the threshold in operation 808, the reference pictures of the neighboring blocks having the residue costs that are less than the threshold among the reference pictures of the neighboring blocks are determined to be the reference pictures of the present block in operation 809. In operation 810, the type of the reference pictures of the neighboring blocks determined to be the reference pictures of the present block is determined to be the second type.

If one of residue costs obtained as a result of motion estimation performed using the reference pictures of the neighboring blocks is not less than the threshold in operation 808, reference pictures of blocks included in a slice including the present block among the reference pictures included in the reference index list are selected in operation 811. Like the reference pictures of the neighboring blocks, there are several reference pictures in the slice. Thus, there is a problem concerning selection of the reference picture from the slice. In this case, as described above, selection of the reference picture is made according to the type of the reference pictures, the residue costs, and/or the order according to the inter prediction mode.

In operation 812, motion estimation is performed on the present block using the reference pictures of the blocks included in the slice. If one of the residue costs obtained as a result of motion estimation performed using the reference pictures of the blocks included in the slice is less than the threshold in operation 813, the reference pictures having the residue costs that are less than the threshold among the reference pictures of the blocks included in the slice are determined to be the reference pictures of the present block in operation 814. Then the type of the determined reference pictures of the blocks included in the slice is determined to be the third type in operation 815.

If all the residue costs obtained as a result of motion estimation performed using the reference pictures of the blocks included in the slice are not less than the threshold in operation 813, the reference pictures included in the reference index list are determined to be the reference pictures of the present block in operation 816. Like the reference pictures of the neighboring blocks of the present block or the reference pictures of the blocks included in the slice, there are several reference pictures included in the reference index list. Thus, a problem concerning selection of a reference picture from the reference index list is caused. In this case, as described above, selection of the reference picture is made according to the type of the reference picture, the residue costs, and/or the order according to the inter prediction mode.

In operation 817, motion estimation is performed on the present block using the reference pictures included in the reference index list. If one of the residue costs obtained as a result of motion estimation performed using the reference pictures included in the reference index list is less than the threshold in operation 818, the reference pictures having the residue costs that are less than the threshold among the reference pictures included in the reference index list are determined to the reference pictures of the present block in operation 819. Then the type of the determined reference pictures included in the reference index list is determined to be the fourth type.

If all the residue costs obtained as a result of motion estimation performed using the reference pictures included in the reference index list are not less than the threshold in operation 821, the reference picture having the smallest residue cost among all the residue costs obtained as a result of motion estimation using the temporally closest reference picture, the reference pictures of the neighboring blocks, the reference pictures of the blocks included in the slice, and the reference pictures included in the reference index list are determined to be the reference pictures of the present block in operation 821.

If the smallest residue cost of the determined reference pictures is obtained using the temporally closest reference picture, the type of the determined reference pictures is determined to be of the first type. If the smallest residue cost is obtained using the reference pictures of the neighboring blocks, the type of the determined reference pictures is determined to be of the second type. If the smallest residue cost is obtained using the reference pictures of the blocks included in the slice, the type of the determined reference pictures is determined to be of the third type. If the smallest residue cost is obtained using the reference pictures included in the reference index list, the type of the determined reference pictures is determined to be of the fourth type.

As described above, according to the present invention, the amount of computation imposed on the encoder can be reduced by preferentially performing motion estimation on a reference picture having high possibility of being determined to be a reference picture instead of performing motion estimation on all plural reference pictures. Such reduction is great particularly in H.264 standards where the reference picture can be selected in units of not only 16×16 macroblocks but also 8×8 subblocks. Therefore, computational complexity and architectural complexity of the encoder can be alleviated to realize the encoder supporting higher display quality and compression rate without a compromise between them.

The embodiment of the present invention can also be programmed as computer executable programs and can be implemented in general-purpose digital computers using computer readable recording media.

The structure of data used in the embodiment of the present invention can be recorded in computer readable recording media using various means.

The computer readable recording media include all kinds of recording media such as magnetic recording media (e.g., ROM, floppy disk, and hard disk), optical reading-out media (e.g., CD-ROM and DVD), and carrier wave (e.g., transmissions via the Internet).

Although a few embodiments of the present invention have been shown and described, it would be appreciated by those skilled in the art that changes may be made in these embodiments without departing from the principles and spirit of the invention, the scope of which is defined in the claims and their equivalents.

1. A method of motion estimation comprising:
selecting one candidate reference picture from a plurality of reference pictures based on priorities of the plurality of reference pictures to determine a reference picture of a predetermined block that belongs to a plurality of blocks forming a present picture; and
performing motion estimation on the predetermined block using the selected candidate reference picture.

2. The method of claim 1, further comprising determining the selected candidate reference picture to be the reference picture of the predetermined block, if a value obtained as a result of performing motion estimation is less than a threshold.

3. The method of claim 2, wherein the value is a residue cost.

4. The method of claim 1, wherein a temporally closest reference picture is selected as the candidate reference picture from the plurality of reference pictures when motion estimation is performed on the predetermined block.

5. The method of claim 4, further comprising selecting the candidate reference picture from reference pictures of neighboring blocks of the predetermined block, if a value obtained as a result of motion estimation performed using the temporally closest candidate reference picture is not less than the threshold.

6. The method of claim 1, wherein, among the plurality of reference pictures, the candidate reference picture is selected from reference pictures of neighboring blocks.

7. The method of claim 6, further comprising selecting the candidate reference picture from reference pictures of blocks included in a slice including the predetermined block, if all values obtained as a result of motion estimation performed using the reference pictures of the neighboring block are not less than a threshold.

8. The method of claim 1, wherein, among the plurality of reference pictures, the candidate reference picture is selected from the reference pictures of the blocks included in the slice including the predetermined block.

9. The method of claim 8, further comprising selecting the candidate reference picture from reference pictures included in a reference index list including the predetermined block among the plurality of reference pictures, if all values obtained as a result of motion estimation performed using the reference pictures of the blocks included in the slice are not less than the threshold.

10. The method of claim 1, wherein, among the plurality of reference pictures, the candidate reference picture is selected from the reference pictures included in a reference index list including the predetermined block.

11. The method of claim 10, wherein if all values obtained as a result of motion estimation performed using the reference pictures included in the reference index list are not less than a threshold, a reference picture having a smallest value among the obtained values is determined to be the reference picture of the predetermined block.

12. A method of motion estimation comprising:
selecting a candidate reference picture as a reference picture of a predetermined block that belongs to a plurality of blocks forming a present picture from a plurality of reference pictures having respective types that indicate priorities, based on the respective types; and
performing motion estimation on the predetermined block using the selected candidate reference picture,
wherein the plurality of reference pictures are used as reference pictures when motion estimation is performed on at least one block that belongs to the plurality of blocks forming the present picture and is different from the predetermined block.

13. The method of claim 12, wherein when motion estimation is performed on the at least one block, the respective priority types are determined to be a first type if a predetermined reference picture of the plurality of reference pictures is used as a temporally closest reference picture, a second type if the predetermined reference picture is used as reference pictures of neighboring blocks of the at least one block, a third type if the predetermined reference picture is used as reference pictures of blocks included in a slice including the at least one block are used, and a fourth type if the predetermined reference picture is used as reference pictures included in a reference index list including the at least one block.

14. The method of claim 13, wherein when the candidate reference picture is selected from the reference pictures of the neighboring blocks, from the reference pictures of the blocks included in the slice, or the reference pictures included in the reference index list, selection is made in order of the reference picture having the first type, the reference picture having the second type, the reference picture having the third type, and then the reference picture having the fourth type.

15. The method of claim 13, wherein when the candidate reference picture is selected from the reference pictures of the neighboring blocks, from the reference pictures of the blocks included in the slice, or the reference pictures included in the reference index list, selection is made in order of the reference picture having the fourth type, the reference picture having the third type, the reference picture having the second type, and then the reference picture having the first type.

16. An apparatus of motion estimation comprising:
a reference picture selecting unit, which selects one candidate reference picture from a plurality of reference pictures based on priorities of the plurality of reference pictures to determine a reference picture of a predetermined block that belongs to a plurality of blocks forming a present picture; and
a motion estimation performing unit, which performs motion estimation on the predetermined block using the selected candidate reference picture.

17. The apparatus of claim 16, further comprising a reference picture determining unit that determines the selected candidate reference picture to be the reference picture of the predetermined block, if a value obtained as a result of performing motion estimation is less than a threshold.

18. The apparatus of claim 17, wherein the value is a residue cost.

19. The apparatus of claim 18, wherein the reference picture selecting unit selects a temporally closest reference picture as the candidate reference picture from the plurality of reference pictures when motion estimation is performed on the predetermined block.

20. The apparatus of claim 19, wherein the reference picture selecting unit selects the candidate reference picture from reference pictures of neighboring blocks of the predetermined block, if the value obtained as a result of motion estimation performed using the temporally closest candidate reference picture is not less than the threshold.

21. The apparatus of claim 20, wherein the reference picture selecting unit selects the candidate reference picture from reference pictures of blocks included in a slice including the predetermined block, if all values obtained as a result of motion estimation performed using the reference pictures of the neighboring blocks are not less than the threshold.

22. The apparatus of claim 21, wherein the reference picture selecting unit selects the candidate reference picture from reference pictures included in a reference index list including the predetermined block among the plurality of reference pictures, if all values obtained as a result of motion estimation performed using the reference pictures of the blocks included in the slice are not less than the threshold.

23. The apparatus of claim 22, wherein if all values obtained as a result of motion estimation performed using the reference pictures included in the reference index list are not less than the threshold, the reference picture determining unit determines a reference picture having a smallest value among the obtained values to be the reference picture of the predetermined block.

24. The apparatus of claim 23, further comprising a reference picture type determining unit that determines the respective picture types to be a first type if a predetermined reference picture of the plurality of reference pictures is used as a temporally closest reference picture, a second type if the predetermined reference picture is used as reference pictures of the neighboring blocks of at least one block, a third type if the predetermined reference picture is used as reference pictures of blocks included in a slice including the at least one block are used, and a fourth type if the predetermined reference picture is used as reference pictures included in a reference index list including the at least one block, when motion estimation is performed on the at least one block.

25. The apparatus of claim 24, wherein when the candidate reference picture is selected from the reference pictures of the neighboring blocks, from the reference pictures of the blocks included in the slice, or the reference pictures included in the reference index list, selection is made in order of the reference picture having the first type, the reference picture having the second type, the reference picture having the third type, and then the reference picture having the fourth type.

26. The apparatus of claim 24, wherein when the candidate reference picture is selected from the reference pictures of the neighboring blocks, from the reference pictures of the blocks included in the slice, or the reference pictures included in the reference index list, selection is made in order of the reference picture having the fourth type, the reference picture having the third type, the reference picture having the second type, and then the reference picture having the first type.

27. A computer readable recording medium having recorded thereon a program for performing a method of motion estimation, the method comprising:
selecting one candidate reference picture from a plurality of reference pictures based on priorities of the plurality of reference pictures to determine a reference picture of a predetermined block that belongs to a plurality of blocks forming a present picture; and
performing motion estimation on the predetermined block using the selected candidate reference picture.

28. A computer readable recording medium having recorded thereon a program for performing a method of motion estimation, the method comprising:
selecting a candidate reference picture as a reference picture of a predetermined block that belongs to a plurality of blocks forming a present picture from a plurality of reference pictures having respective types that indicate priorities, based on the respective types; and
performing motion estimation on the predetermined block using the selected candidate reference picture,
wherein the plurality of reference pictures are used as reference pictures when motion estimation is performed on at least one block that belongs to the plurality of blocks forming the present picture and is different from the predetermined block.

29. An encoder comprising:
a motion estimating unit assigning priorities to a plurality of reference pictures and performing motion estimation based on the assigned priorities, wherein the motion estimating unit calculates a motion vector based on a determined reference picture.

30. The encoder of claim 29, further comprising:
a storing unit storing a reference index list and the plurality of reference pictures referenced by the reference index list.

31. The encoder of claim 29, further comprising:
an encoding control unit outputting coding type information and quantization parameter information.

32. The encoder of claim 31, further comprising:
a first encoding unit outputting quantized transform coefficients; and
a second encoding unit receiving, encoding and multiplexing the quantized transform coefficients output by the first encoding unit, the motion vector output from the motion estimating unit and the coding type information and the quantization parameter information output by the encoding control unit, and outputting a bit stream.
